(19) United States
(12) Patent Application Publication
(10) Pub. No.: US 2004/0041922 A1
(43) Pub. Date: Mar. 4, 2004

(54) Digital camera with automatic audio recording background

(75) Inventor: Mitchell Norcross, Harvard, MA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 10/231,439

(22) Filed: Aug. 28, 2002

(51) Int. Cl. H04N 5/76

(52) U.S. Cl. 348/231.4

(57) ABSTRACT

A camera for recording an image and associated audio. The camera activation mechanism also initiates the recording of audio data in the audio memory, with the audio memory being continuously overwritten after a maximum time of audio is recorded. Thus, at any point in time when an image is captured, audio from prior to that time is available, and audio after that time could be recorded, all with the pressing of a single button.

### CROSS-REFERENCES TO RELATED APPLICATIONS

Not applicable

### STATEMENT AS TO RIGHTS TO INVENTIONS MADE UNDER FEDERALLY SPONSORED RESEARCH OR DEVELOPMENT

Not applicable

### REFERENCE TO A “SEQUENCE LISTING,” A TABLE, OR A COMPUTER PROGRAM LISTING APPENDIX SUBMITTED ON A COMPACT DISK

Not applicable

### BACKGROUND OF THE INVENTION

The present invention relates to a camera storing audio in connection with still pictures.

It is desirable to be able to record audio in conjunction with a still picture in order to add another dimension to viewing the pictures later. This is especially true for digital pictures which can be displayed on the computer as part of a slide show, allowing audio to be provided as well.

A number of patents illustrate the recording of audio starting from when the image is taken until a period of time after that. For example, see Kodak U.S. Pat. No. 5,784,525.

A number of other patents disclose recording both before and after the time the image is captured. This typically requires a first button for initiating the audio, and then an image capture button being pressed in the middle of the audio recording. U.S. Pat. No. 5,815,201, assigned to Ricoh, discusses doing an audio enable first, then pressing the shutter release button to save both the image and the audio. Pat. No. Re 36,589, assigned to Olympus, discusses recording audio data just before and after the time of image capture, but without details of how the switching would be done. U.S. Pat. No. 4,602,296, assigned to Fuji, shows a rotating disk on which audio is recorded, with the use of a record switch. This allows audio to be recorded prior to pressing the release button to capture the image.

### BRIEF SUMMARY OF THE INVENTION

The present invention provides a camera for recording an image and associated audio. The camera activation mechanism also initiates the recording of audio data in the audio memory, with the audio memory being continuously overwritten after a maximum time of audio is recorded. Thus, at any point in time when an image is captured, audio from prior to that time is available, and audio after that time can be recorded.

In a preferred environment, the memory is a circular buffer which constantly stores and overwrites the audio data. When an image is captured, several seconds of audio prior to the image capture time is preserved, and not overwritten. The present image thus provides audio recording both before and after an image without requiring a separate button to be activated by a user, thus making it user friendly.

In another embodiment of the invention, fade-in and fade-out of the audio recording is provided for. In particular, after the recording of audio in the circular buffer, the amplitude of the data can be modified to produce the fade-in and fade-out effects, with the data then being stored in the main memory, such as a flash memory card storing the images.

For a further understanding of the nature and advantages of the invention, reference should be made to the following detailed description taken in conjunction with the accompanying drawings.

### BRIEF DESCRIPTION OF THE DRAWINGS

FIG. 1 is a block diagram of a camera incorporating the audio memory of the present invention.

### DETAILED DESCRIPTION OF THE INVENTION

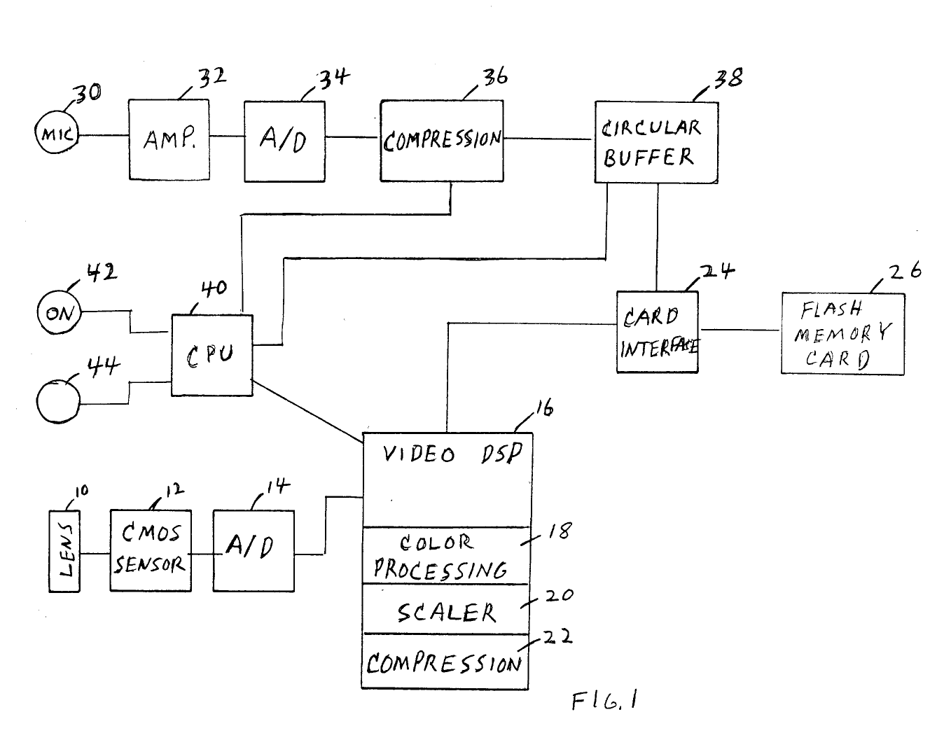

FIG. 1 is a block diagram of a camera according to an embodiment of the invention. FIG. 1 shows a lens 10 for receiving an image, which is provided to a CMOS sensor 12. The image from the sensor is provided through an analog-to-digital (A/D) converter 14. The image is then processed by a video digital signal processor (DSP) 16, which can include a color processing module 18, a scaling model 20, and a compression module 22. The processed image is then sent to a card interface 24, from which it can be stored on the flash memory card 26. Alternately, different circuitry can be used and different memory media can be used, or the image can be sent directly over a bus to remote computer. The foregoing description is merely exemplary of a video camera in which the present invention could be incorporated.

The audio is recorded using a microphone 30 which is provided through an amplifier 32 to an A/D converter 34. The data can then be compressed in compression circuit 36, and provided to the circular buffer 38 in accordance with the present invention. The different circuit elements in FIG. 1 can be controlled by a CPU or processor 40.

In operation, the camera can be turned on by an ON switch 42. CPU 40 will recognize the signal, and initiate the recording of audio in circular buffer 38. The circular buffer is simply a memory allocation scheme where the memory is reused. For example, an index or pointer can point to the starting position and be incremented to write over a previously used location when the buffer has been used up. The circular buffer makes a queue when separate indices are used for inserting and removing data.

When a shutter switch 44 is activated, CPU 40 causes an image to be captured in CMOS sensor 12, and then the image is processed to be stored in flash memory card 26. At the same time, the location of audio in the circular buffer is noted, and a predetermined amount of audio subsequent is recorded. After that time, the overwriting of the audio is stopped, preserving audio both before and after the time of image capture.

CPU 40 then causes the audio recorded in buffer 38 to be stored with the image on flash memory card 26 through card interface 24. The actual storing can be in a separate location on the flash memory card, with a tag in the audio portion indicating which image it corresponds to. Alternately, a tag on the image could identify the location of the audio corresponding to the image. The audio can be compressed before recording, or left uncompressed.

After the audio has been transferred from circular buffer 38 to flash memory card 26, the recording of audio is commenced again, with continuous overwriting of the data in circular buffer 38, to prepare for the next image to be captured.

In one embodiment, a fade-in and fade-out is performed on the audio data. This makes a more pleasant presentation for a subsequent slide show on a computer, by providing a fade-in and fade-out of the audio in between the transition of images. This can be done by CPU 40 causing the amplitude of the audio to be appropriately reduced as the data is transferred from circular buffer 38 to flash memory card 26.

As will be understood by those of skill in the art, the present invention may be embodied in other specific forms without departing from the essential characteristics thereof. For example, a microprocessor instead of a video DSP and separate CPU could be used, or an alternate type of memory from a flash memory card could be used. Accordingly, the foregoing description is intended to be illustrative, but not limiting, of the scope of the invention which is set forth in the following claims.

What is claimed is:

1. A camera comprising:
an image sensor for recording an image;
a microphone for receiving audio;
an audio memory for recording said audio;
a camera activation mechanism for enabling said camera to record images, and simultaneously initiating the recording of audio in said audio memory, said audio memory being continuously overwritten after a maximum time of audio is recorded;
an image capture element, for capturing an image in said image sensor; and
a processor configured to associate with said image an audio recording in said audio memory from a first predetermined amount of time prior to when said image is captured, to a second predetermined amount of time after said image is captured.

2. The camera of claim 1 wherein said processor is further configured to fade-in and fade-out said audio recording associated with said image.

3. The camera of claim 1 wherein said audio memory is a circular buffer.

4. The camera of claim 3 wherein said circular buffer records less than 15 seconds of audio.

5. The camera of claim 3 further comprising a second audio memory for storing audio from said audio buffer after it is associated with an image.

6. The camera of claim 5 wherein said second audio memory is on an image memory flash card for storing said images.

7. The camera of claim 1 wherein said audio recording is associated with said image by storing a tag with one of said image and said audio recording that identifies the memory location of the other.

8. The camera of claim 1 wherein said audio recording is compressed.
